(19) United States
(12) Patent Application Publication
(10) Pub. No.: US 2016/0262423 A1
(43) Pub. Date: Sep. 15, 2016

(54) DEVICE AND METHOD FOR PRODUCING ICE CREAM

(71) Applicant: Christian BROSER, Frankenthal (DE)

(72) Inventor: Christian BROSER, Frankenthal (DE)

(21) Appl. No.: 15/029,561

(22) PCT Filed: Aug. 17, 2015
(86) PCT No.: PCT/EP2015/068816

§ 371 Date: Apr. 14, 2016

(30) Foreign Application Priority Data
Sep. 12, 2014 (DE) 10 2014 113 152.5

(51) Int. Cl. A23G 9/26; A23G 9/22

(52) U.S. Cl. CPC A23G 9/26; A23G 9/221

(57) ABSTRACT

This invention relates to a device and a method for the production of ice cream. The device comprises an immersion bath (1) with an interior space (2) filled with cryogenic liquid, a cassette (3) that can move in the interior space (2) of the immersion bath (1) with chill molds (8), arranged therein, for accommodating ice cream mass, a filling system (7) for filling the chill molds (8) with the ice cream mass, a processing path for freezing solid the cassettes (3) with the chill molds (8), as well as a heating system for thawing chill molds (8), filled with ice cream mass, for a subsequent packaging.

The method for the production of ice cream comprises the treatment of chill molds with liquid nitrogen and the subsequent filling with ice cream mass.

This invention relates to a device for the production of ice cream using chill molds cooled with a cryogenic medium as well as a method for the production of ice cream.

### TECHNICAL FIELD

The conventional production of ice cream comprises multiple steps, whereby first, ingredients corresponding to a desired recipe are mixed to form a premix. This premix is then homogenized and pasteurized, before it is intermediately stored in curing tanks. Then, the premix is exposed to air and prefrozen to a creamy consistency. The freezing and exposure to air were previously performed in separate coolers with quick-rotating mixing tools. If necessary, additions such as, for example, fruits, chocolate, or candies are introduced into the ice cream.

### STATE OF THE ART

The use of cryogenic media such as liquid nitrogen in the case of food production is known in the art. Thus, for example, it is proposed in DE 197 13 505 A1 for the introduction of additions into the ice cream that the additions be flash-frozen in the cryogenic liquid, for example in liquid nitrogen or in carbon dioxide.

In the known methods, it is shown that the freezing speed influences the size and position of the ice crystals that are forming, which is decisive for the product quality. If plant tissues, as they are present in, for example, pulp or fruit pieces, are frozen slowly, cell membranes are damaged and partially destroyed. When sherbet thaws (e.g., when being eaten), cellular water oozes out, which results in an unattractive consistency of the ice.

Also, in DE 10 2006 019 700 A1, the ice cream mass is brought into contact directly with a cryogenic medium (liquid nitrogen), whereby the freezing and exposure to air is performed in a mixer, into which the cryogenic medium is fed. In DE 10 2010 017 928 A1, the ice cream mass or components thereof are treated with a cryogenic medium, in which the ingredients are first mixed to form a premix, and the premix is prefrozen with a cryogenic medium. During the prefreezing, lumpy additives are added to the premix. The method described therein thus makes possible the introduction and the incorporation of lumpy additives in ice cream using a cryogenic medium.

It is disadvantageous in the case of the direct treatment of ice cream or its components with a cryogenic medium that different forms of ice cream and consistencies can be produced only with difficulty or not at all. In particular, as far as the requirements regarding texture and creaminess are concerned, it is decisive that the formation of crystallization buds be significantly decreased, which could be achieved with the previously known production method only with considerable use of various additives and a large volume of introduced air. Also, the known methods are limited with respect to the possible recipes, since for obtaining texture and creaminess, special additives are necessary. The above-described methods do not allow, moreover, any angular or polygonal forms of ice.

### PRESENTATION OF THE INVENTION

Against this background, the object of this invention is to provide an improved device and a method for the production of ice cream using a cryogenic medium, in particular liquid nitrogen or liquid carbon dioxide, in which the addition of additives for the development of texture, form and creaminess can be eliminated and in which a uniform crystallization is achieved with the simultaneous production of new, precise, angular or polygonal forms of ice.

This object is achieved by a device with the features of Claim 1 and a method with the features of Claim 10. Preferred embodiments are recapped in the subclaims.

The device according to the invention for the production of ice cream consists of multiple processing stations, whereby the heart of the invention during freezing is in the previously prepared ice cream mass using cooled chill molds. The device comprises an immersion bath, for example a tub or a container, with an interior space that is filled with a cryogenic medium. Preferably, liquid nitrogen is used as a cryogenic medium, which is prepared from a storage container. In order to prevent excessive formation of ice, a heating wire or other heating system can be provided within the immersion bath for temperature regulation in a preferred variant. According to the invention, a cassette that can be moved into the interior space of the immersion bath is also provided, which can accommodate one or more chill molds for accommodating ice cream mass. The chill molds are used as shape-imparting matrices and give to the ice cream the corresponding three-dimensional geometric shape. The chill molds are suspended in the cassette or fastened in the latter, whereby the cassette is preferably designed for a large number of chill molds for the production of large amounts of ice cream, for example for mass production. Preferably, the chill mold is configured in such a way that multiple servings of ice cream can be frozen and shaped. Preferably, the cassette is lowered with the chill molds into the cryogenic medium of the immersion bath or the immersion bath is lifted and left for a specific immersion time in the immersion bath. In terms of this invention, the immersion time defines the contact period of the chill molds with the cryogenic medium of the immersion bath. The immersion time is based on the type, the shape, and the material of the chill molds as well as the ice cream mass used. In another variant, the chill molds are conveyed via a conveying system directly to the immersion bath and come into contact there with the cryogenic medium. Preferably, chill molds are used that have a high cold storage capacity, whereby chill molds that are made of metal are preferred. The latter are insensitive with respect to the treatment with the cryogenic medium (e.g., nitrogen, carbon dioxide).

After the immersion time elapses, the cassette with the chill molds is removed from the immersion bath. Then, the chill molds are filled with ice cream mass via a filling opening. The filling is done preferably via a metering system, with which a serial or simultaneous filling of the chill molds with the ice cream mass is possible. Preferably, the metering system is automated, for example with the aid of a robot. Then, for a specified time period, the freezing-solid of the cassettes over a processing path, preferably in the form of an automated transport mechanism for the cassettes equipped with the chill molds, is carried out.

The device according to the invention also preferably comprises a heating system for thawing the chill molds filled with ice cream mass, for example for a subsequent further processing, such as, e.g., drying, coating, or packaging. Preferably, the heating system is a heating bath, in which are immersed the chill molds that are removed from the immersion bath filled with the cryogenic medium or the cassettes with chill molds after the filling and the elapsed time of freezing solid. The medium of the heating bath (e.g., water) preferably has a temperature of >0° C., preferably between 2-10° C. or more. This temperature difference is adequate. As an alternative, the heating system can comprise a heating means for heating the chill molds, for example a hot-air blower, a system for microwave exposure, or an infrared illumination unit. In such a variant, the heating system can be moved to the cassette with the chill molds or the cassette can be moved to the heating system.

For the production of ice cream, in most cases, it is necessary to set ice cream sticks. In a preferred variant, the setting of sticks is carried out with or after the filling of chill molds with the ice cream mass. Immediately after the filling of chill molds with the ice cream mass, the core of the ice cream is still not frozen, in contrast to its shell, so that the sticks can be easily inserted. Only with increasing freezing time is the ice cream completely frozen solid by releasing cold energy from the chill molds to the ice cream and as a result is also firmly connected to the sticks. For setting the sticks, a stick-setting system is provided, with which the setting of sticks can be done either serially or simultaneously. Preferably, this process is also automated, for example using a robot. After the ice cream mass is frozen, the transfer of the chill molds to a possible optional heating system is done in order to loosen the ice cream mass for subsequent further processing steps, such as, for example, packaging, coating or drying.

The individual working steps are ultimately dependent upon the number and size of the entire ice cream production unit and the capacity of the chill molds that are to be processed. Thus, the immersion of the chill molds in the immersion bath filled with the cryogenic medium is carried out for an immersion time that is preset for cooling the chill molds, a time that is preferably less than 3 minutes (180 seconds), especially preferably less than 1:30 minutes (90 seconds). After the subsequent filling of the chill molds that are cooled down in the cryogenic medium, the ice cream mass is frozen in the chill molds for a time period that is sufficient to freeze the ice cream mass to the core but in this case to avoid cracking. At the same time, the sticks are set. Preferably, this process lasts less than two minutes.

In a preferred embodiment, the device according to the invention comprises sensors for regulating the liquid level of the liquid cryogenic medium in the interior space of the immersion bath, via a storage container for the cryogenic medium that is connected to the immersion bath. In this case, the liquid level of the cryogenic medium in the immersion bath is determined and compared to a nominal level (interval). When the value drops below the actual value compared to a specified minimum value for the nominal level, filling of the immersion bath is done via a nitrogen supply for maintaining the liquid level. The nominal level therefore allows a certain margin or tolerance for additionally supplying the immersion bath with the cryogenic medium, in particular since the liquid “works” in the immersion bath and does not stand still. Preferably, the storage container is a nitrogen reserve tank that is connected via lines to the interior space of the immersion bath. Valves are opened, if necessary, via a control system in order to ensure a uniform liquid level in the interior space of the immersion bath.

In a preferred embodiment, the device comprises a lifting system, with which lowering and/or lifting of the cassette or of the immersion bath filled with the cryogenic medium is possible. The lifting system is advantageous in particular in the case of a limited-lot production. The lifting system comprises a control system, which controls the lifting movement of the lifting system based on the immersion time and/or the temperature of the chill molds immersed in the immersion bath. If the necessary immersion time and/or temperature for cooling down the chill molds in the immersion bath that is filled with the cryogenic medium is achieved, the control system makes possible the lifting of the cassette or the lowering of the immersion bath for the subsequent filling of the chill molds. As an alternative, the lifting system can also be replaced by a conveying system, for example a clock belt.

In a preferred variant, the cassette comprises individual compartments, separate from one another, for accommodating the individual chill molds. The bottom of the cassette is preferably open on its lower side, so that the chill molds can come completely into contact with the cryogenic medium. The compartments are separated from one another by intermediate walls. The chill molds are on both sides of the longitudinal sides of the cassette on carrier elements mounted thereon. To improve worker safety, the cassette is accommodated in a cage made of perforated plate or metal mesh. The perforated plate or the metal mesh ensures that a worker cannot accidentally reach from above into the immersion bath with the cryogenic liquid. At the same time, a sufficient circulation of the chill molds with the cryogenic medium is ensured.

The chill molds themselves preferably consist of two halves that can be hinged and that on the top comprise at least one feed hopper for the ice cream mass and physical volume shape profiles for the ice cream. In the closed state, the individual chill mold halves are held together by a closure mechanism. In this connection, for example, a clamping connection, catching connection, or snap connection can be selected as a closure mechanism. The configuration of the physical volume shape profiles ultimately depends on what ice forms are to be produced. The profiles thus represent matrices for the respective ice forms and can have any geometry.

The use of liquid nitrogen as a cryogenic medium is preferred, since in comparison to liquid carbon dioxide, lower temperatures of up to −196° C. can be achieved. An efficient flash-freezing of the ice cream mass is made possible by the extremely high temperature difference.

The method according to the invention has the advantage that based on the flash-freezing, ice crystals can also form inside the cell, which leads to a uniform crystallization for example in a plant tissue (e.g., pulp or fruit pieces). Even after thawing, the texture of the ice thus stays the same to a large extent, and the oozing of cellular water is less in comparison to conventional methods. Thus, the consumption of sherbet as it thaws is also more pleasant.

By the method according to the invention, moreover, amorphous crystal structures are avoided by the size and number of the crystallization buds being significantly minimized. The ice cream that is produced according to the invention has a texture and creaminess, based on the rapid temperature drop, which would be achieved with conventional production methods only with considerable use of different additives and a large amount of air introduced. The method according to the invention is suitable, moreover, for adding extras such as, for example, fruit pieces, candies, or other components, as they are known in the field of ice cream production. In this connection, the production method allows the introduction of new recipes, since the production can be carried out completely by biological ingredients without additives. Thus, for example, vegan ice or alcohol-containing recipes (also as ice on a stick) can be easily produced. Depending on the type of ice cream, the necessary immersion times must be optimized during the immersion process or the time of freezing solid of the chill molds with the ice cream mass. In comparison to conventional methods, the production method according to the invention is no longer consistency-oriented, i.e., not dependent on a solid ratio between sugar, fat, and air. This makes possible a receptor-oriented production of ice cream, by which recipes that are healthier and up until now that could be achieved only at great expense can be produced. In a variant, an exemplary ice cream mass comprises yogurt with mango puree, rosemary, coconut milk, Madagascar vanilla, coconut blossom syrup, but no unnecessary additives.

The production method according to the invention makes possible, moreover, the production of specific angular and polygonal ice forms, which would not be possible with conventional technology. This contributes decisively to a high recognition value. The chill molds according to the invention make possible ice matrices that in their composition and their materials ensure a uniform release of cold energy to the ice cream mass.

### BRIEF DESCRIPTION OF THE DRAWINGS

The invention is explained in more detail in the drawings below. Here:

FIG. 1 shows an overview on the method according to the invention and some device components,

FIG. 2 shows an embodiment of a cassette for accommodating chill molds,

FIG. 3 shows an embodiment of a chill mold for the ice cream machine.

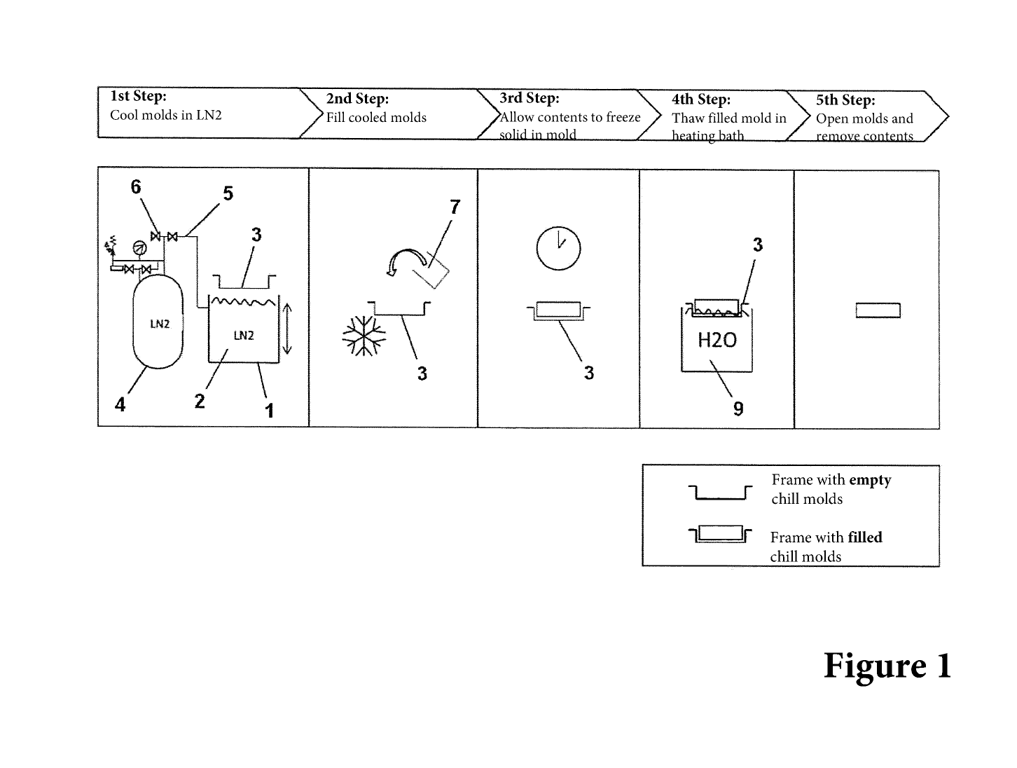

In FIG. 1, the process sequence of the method according to the invention is shown diagrammatically. In a first step, the cooling of the chill molds 8 is carried out in an immersion bath 1 with the aid of liquid nitrogen as a cryogenic medium. The immersion bath 1 has an interior space 2, which is filled with the cryogenic medium, which in turn is provided from a storage container 4. The supply of nitrogen is done via supply lines 5, which can be closed via valves 6. The valve control system (not shown) can be dependent upon, for example, the liquid level in the immersion bath 1.

The chill molds 8 (not shown) are transferred via a cassette 3 into the immersion bath 1, preferably via a lifting system, and remain there for an immersion time that is sufficient to maintain the desired temperature difference.

As an alternative, the cassettes 3 can be moved with a suitable conveying system through the immersion bath 1 (not shown). After the chill molds 8 are cooled in the immersion bath 1, the cassettes 3 with the chill molds 8 are removed from the immersion bath 1, so that in the next step, a filling of the chill molds 8 with the ice cream mass can be carried out. For filling, a filling system 7 is provided for the ice cream mass, shown diagrammatically by a container. Depending on the unit configuration, metering systems such as pipettes or guns are used, which are preferably fully-automated or robot-controlled. After filling and setting sticks, freezing is performed in a third step, in which the ice cream mass is frozen. For this purpose, the cassettes 3 are frozen with the chill molds 8 preferably via a conveying mechanism for a specified time of freezing solid based on the respective recipe. Because of the matrices of the chill molds 8, the contents obtain the desired shape. At the same time, in this method step, preferably at the beginning, the setting of the sticks can also be carried out. This is possible as long as the core of the ice cream mass is not completely frozen. In a fourth step, the loosening of the ice cream from the chill molds 8 is carried out by treatment in a heating system 9. For this purpose, the cassette 3 is immersed with the chill molds 8 (or only the individual chill molds 8) in the heating system 9, a heating bath with heating water in the embodiment shown. Then, in the fifth step below, the molds can be opened, and the refrigerated goods can be removed. As an alternative, the loosening of the ice cream from the chill molds can also be carried out via a hot-air blower.

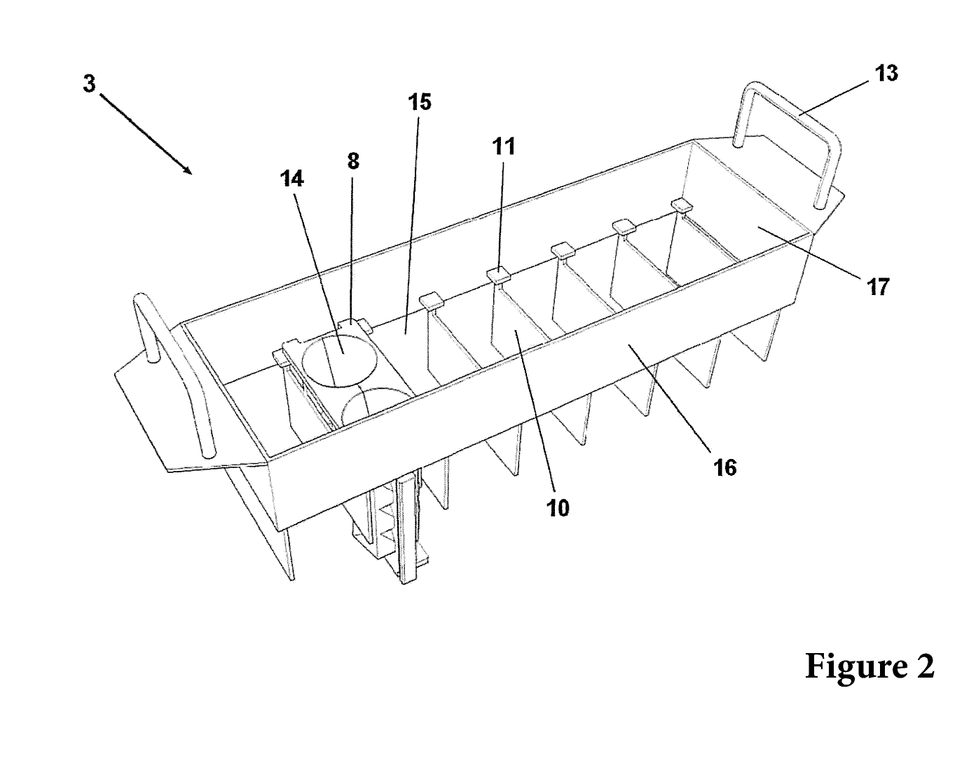

In FIG. 2, a cassette 3 for accommodating the individual chill molds 8 is shown. In this connection, the bottom 15 of the cassette 3 is open, so that the chill molds 8 can be flushed from below with the cryogenic medium. The individual chill molds 8 are added in compartments that are separate from one another and that are separated from one another by intermediate walls 10. Carrier elements 11 for holding the chill molds 8 are located on the longitudinal sides 16 of the cassette 3. In the case of the chill molds 8, the feed hopper 14 for the ice cream mass can be seen from above. Holding clips 13 for manual carrying or for mounting the cassette 3 in a conveying system are located, moreover, on the front sides 17.

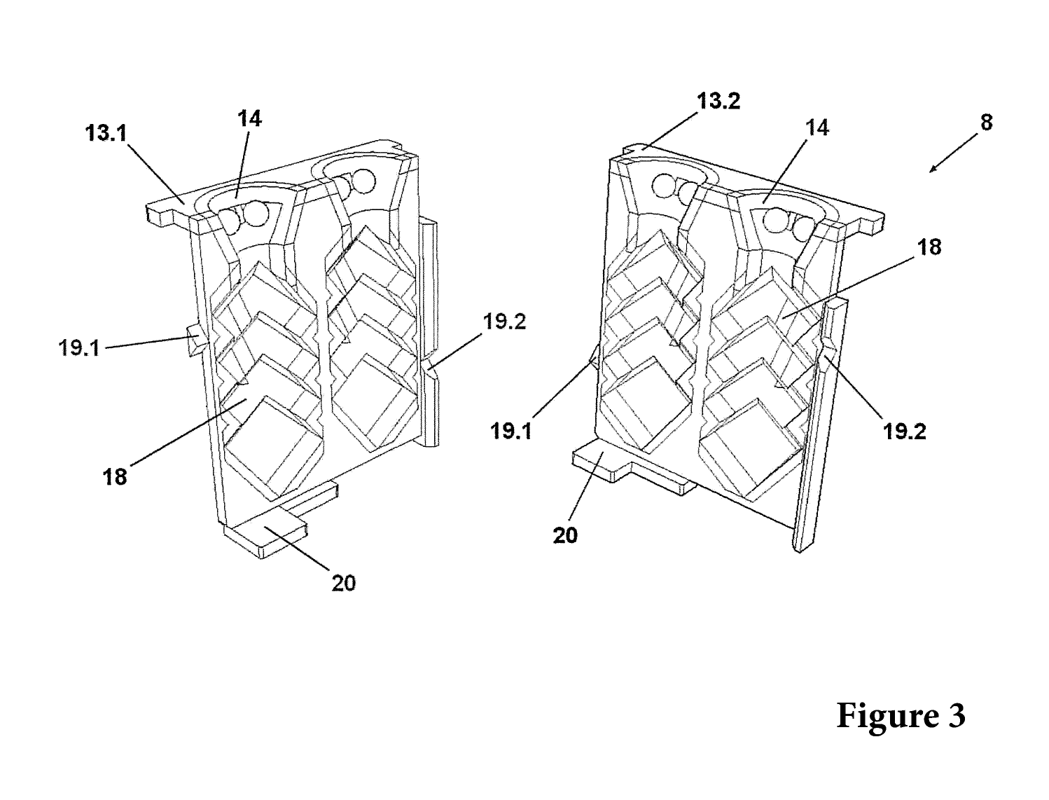

In FIG. 3, an embodiment of a chill mold 8 according to the invention is shown. The latter consists of two halves 13.1, 13.2 that can be hinged. In the interior, two physical volume shape profiles 18 for producing the geometric appearance of the ice cream can be seen. In the variant embodiment shown, two servings of ice cream can thus be produced. Via corresponding clamping elements 19.1, 19.2, the two halves 13.1, 13.2 can be folded together and locked. In the variant shown, the clamping hub 19.1 of the first chill mold half 13.1 locks the second chill mold half 13.2 into a mating clamping cavity 19.2. Also, holding elements 20 can still be seen on the bottom of the chill mold 8. The filling is done in the case of the cooled chill molds 8 in each case via a feed hopper 14 on the top of the chill molds 8.

1-16. (canceled)

17. Device for the production of ice cream, comprising
An immersion bath (1) with an interior space (2) filled with liquid cryogenic medium,
At least one cassette (3), movable in the interior space (2) of the immersion bath (1), with chill molds (8) arranged therein for accommodating ice cream mass,
A filling system (7) for filling the chill molds (8) with the ice cream mass,
A stick-setting system for setting sticks, characterized in that the chill molds (8) consist of two halves (13.1, 13.2) that can be hinged and that impart the geometric shape to the ice cream as a shape-imparting matrix.

18. Device according to claim 17, wherein a heating system (9) is also provided for thawing chill molds (8) filled with ice cream mass for a subsequent further processing of the ice cream.

19. Device according to claim 17, wherein the immersion bath (1) comprises sensors for regulating the liquid level of the liquid cryogenic medium in the interior space (2) via a storage container (4) for the cryogenic medium that is connected to the immersion bath (1).

20. Device according to claim 17, wherein a lifting system is provided, with which lifting to immerse the cassette (3) is done, and lowering of the immersion bath (1) or as an alternative lowering and lifting of the cassette (3) is done.

21. Device according to claim 20, wherein the lifting system comprises a control system, which controls the lifting movement of the lifting system based on the immersion time of the chill molds (8) immersed in the immersion bath (1).

22. Device according to claim 17, wherein a conveying system is provided, with which the cassettes (3) can be conveyed to the immersion bath (1).

23. Device according to claim 17, wherein the cassette (3) comprises individual compartments, separated from one another, for accommodating the individual chill molds (8), whereby the bottom (15) of the cassette (3) is open on its lower side, the compartments are separated from one another by intermediate walls (10), and the chill molds (8) rest on carrier elements (11) on both sides of the longitudinal sides (16) of the cassette (3).

24. Device according to claim 17, wherein for worker safety, the cassette (3) is accommodated in a cage that consists of perforated plate or metal mesh.

25. Device according to claim 17, wherein the two halves (13.1, 13.2) of the chill molds (8) that can be hinged comprise a feed hopper (14) and physical volume shape profiles (18) for the ice cream and in the closed state are held together by a closure mechanism.

26. Device according to claim 18, wherein the heating system (9) comprises a heating bath or a hot-air blower.

27. Device according to claim 17, wherein in addition, a heating wire is provided in the immersion bath (1).

28. Method for the production of ice cream, in which a chill mold is first cooled by a treatment with a cryogenic medium and then is filled with the ice cream mass, characterized by the steps:
a. Preparation of an immersion bath with an interior space filled with the liquid cryogenic medium,
b. Transfer of the chill molds into the immersion bath for an immersion time specified for cooling the chill molds,
c. Hauling out the cooled chill molds from the immersion bath and filling the chill molds with ice cream mass,
d. Freezing the ice cream mass in the chill molds for a period of time that is sufficient to freeze the ice cream mass to the core, avoiding cracking, whereby with or after the filling of the chill molds with the ice cream mass, the setting of sticks in the ice cream is done.

29. Method according to claim 26, wherein the liquid level of the liquid cryogenic medium in the immersion bath is determined and is compared to a nominal level, whereby when the value drops below the actual value compared to the minimum value of the nominal value level, filling of the immersion bath is done via a medium supply for maintaining the liquid level.

30. Method according to claim 28, wherein the chill molds are filled serially or simultaneously with the ice cream mass via a metering system.

31. Method according to claim 28, wherein the transfer of the chill molds into the immersion bath is done by immersion.

32. Method according to claim 28, wherein a treatment of the chill molds with a heating system for loosening the ice cream mass and for preparing for a subsequent further processing is carried out.

33. Method according to claim 32, wherein the treatment of the chill molds with the heating system comprises an immersion in a heating bath or a hot-air treatment.
